(19) United States
(12) Patent Application Publication
(10) Pub. No.: US 2021/0211217 A1
(43) Pub. Date: Jul. 8, 2021

(54) SYSTEMS AND METHODS FOR WAVELENGTH IDENTIFICATION IN OPTICAL FIBERS

(71) Applicant: AFL Telecommunications LLC, Duncan, SC (US)

(72) Inventors: Michael Scholten, Westford, MA (US); Scott Prescott, Belmont, NH (US); Dale C. Eddy, Gilford, NH (US); W. Lee Woodworth, Penacook, NH (US)

(21) Appl. No.: 17/140,836

(22) Filed: Jan. 4, 2021

Related U.S. Application Data
(60) Provisional application No. 62/958,055, filed on Jan. 7, 2020.

(51) Int. Cl. H04J 14/02; G02B 6/42; H04B 10/25; H04B 10/572; H04B 10/69

(52) U.S. Cl. CPC H04J 14/02; G02B 6/4286; H04B 10/69; H04B 10/572; H04B 10/25

(57) ABSTRACT

A method of wavelength identification in an optical fiber includes emitting light into the optical fiber. The light includes a data burst defining a wavelength identification code. The method also includes reading the wavelength identification code with a device. In an embodiment, the device can include an optical power meter. The method further includes automatically adjusting a wavelength of the device to the wavelength defined in the wavelength identification code. The method can further include displaying the wavelength of the light and a detected power level.

### FIELD

The present disclosure relates to fiber optics. In particular, the present disclosure relates to systems and methods for wavelength identification in one or more optical fibers.

### BACKGROUND

Multiplexers (mux) and demultiplexers (demux) are used to combine and separate signals on optical fibers. Correctly identifying signal outputs is critical to ensuring system operability. However, Wavelength Division Multiplexing (WDM) demux (filter) outputs are sometimes improperly labeled. For example, while WDM filter outputs may use a channel-numbering, frequency, or some other labeling scheme to identify outputs, many types of channel numbering schemes exist, rendering channel numbers unreliable for mapping wavelengths. Moreover, channels may be mislabeled on the output line, rendering useless any visual inspection by an operating technician.

Present means and methods of detecting and measuring which wavelength is present in a WDM filter output requires a channel checker, Optical Spectrum Analyzer (OSA), or WDM Health Meter using wavelength filtering technology. Such methods are very expensive due to their required filtering technology and are limited to the wavelengths they can detect and report based on the filter integrated into the test set.

Accordingly, improved methods for wavelength identification in optical fibers are desirable.

### BRIEF DESCRIPTION

Aspects and advantages of the invention are set forth below in the following description, or may be obvious from the description, or may be learned through practice of the invention.

In one exemplary aspect of the present disclosure, a method of wavelength identification in an optical fiber is provided. The method includes generating a wavelength identification code defining a wavelength associated with a light to be emitted into the optical fiber. The method also includes integrating the wavelength identification code into a data burst associated with the light. The method further includes emitting the light into the optical fiber. The light travelling in the optical fiber thus includes readable information identifying its wavelength.

In another exemplary aspect of the present disclosure, a device is configured for use with an optical fiber and includes processing circuitry coupled to storage. The processing circuitry is configured to generate a wavelength identification code defining a wavelength associated with a light. The processing circuitry is further configured to integrate the wavelength identification code into a data burst associated with the light. The processing circuitry is additionally configured to communicate the data burst to a wavelength-adjustable light source configured to emit the light into the optical fiber.

In yet a further exemplary aspect of the present disclosure, a method of wavelength identification in an optical fiber includes emitting light into the optical fiber. The light comprises a wavelength identification code defining a wavelength of the light. The method further includes reading the wavelength identification code with a device. The device may include, e.g., an optical power meter. The device can automatically adjust to the wavelength defined in the wavelength identification code. That is, the device can automatically tune to the wavelength of the light in response to the wavelength identification code. The method can further include displaying the wavelength of the light and a detected power level.

These and other features, aspects and advantages of the present disclosure will become better understood with reference to the following description and appended claims. The accompanying drawings, which are incorporated in and constitute a part of this specification, illustrate embodiments of the disclosure and, together with the description, serve to explain the principles of the disclosure.

### BRIEF DESCRIPTION OF THE DRAWINGS

A full and enabling disclosure of the present disclosure, including the best mode thereof to one skilled in the art, is set forth more particularly in the remainder of the specification, including reference to the accompanying figures.

FIG. 1 provides a flow chart of an exemplary method of wavelength identification of optical fibers according to one or more embodiments of the present subject matter.

FIG. 2 provides a flow chart of an exemplary method of wavelength identification of optical fibers according to one or more embodiments of the present subject matter.

FIG. 3 is a schematic illustration of a plurality of optical fibers and a light source which may emit light into the optical fibers in accordance with one or more embodiments of the present subject matter.

FIG. 4 is a schematic illustration of an exemplary optical power meter device which may be used during wavelength identification methods in accordance with one or more embodiments of the present disclosure.

FIG. 5 is a schematic illustration of an exemplary optical power meter device which may be used during wavelength identification methods in accordance with one or more embodiments of the present disclosure.

FIG. 6 illustrates a single wavelength transmission optical output configuration according to one or more embodiments of the present disclosure.

FIG. 7 illustrates a multiple wavelength transmission optical output configuration according to one or more embodiments of the present disclosure.

FIG. 8 is a schematic illustration of a two-byte signal used for wavelength identification according to one or more embodiments of the present disclosure.

FIG. 9 is a schematic illustration of a device for wavelength identification in optical fibers according to one or more embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

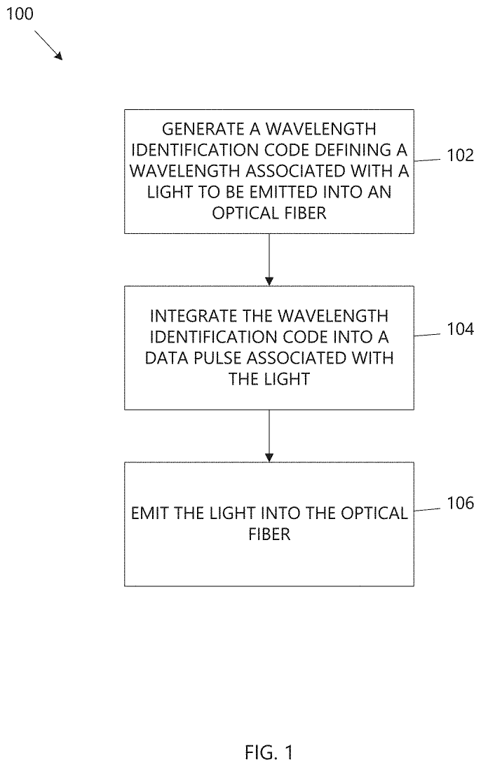

Embodiments of the present subject matter include methods of wavelength identification in one or more optical fibers, such as the exemplary method 100 illustrated in FIG. 1. The exemplary method 100 may be used with any suitable optical fiber(s), such as one or more optical fiber(s) which may be used, e.g., in a ribbon, cable, data cord, etc. The method 100 of wavelength identification may include a step 102 of generating a wavelength identification code defining a wavelength associated with a light to be emitted into an optical fiber. The defined wavelength identification code can provide a wavelength value of the emitted light. In at least some embodiments, the wavelength may be one of several wavelengths which are combined using Dense Wavelength Division Multiplexing (DWDM) or Coarse Wavelength Division Multiplexing (CWDM). For example, the wavelength may be in a range of 800 nanometers (nm) and 1625 nm, such as in a range of 1000 nm and 1600 nm, such as in a range of 1250 nm and 1600 nm. By way of a non-limiting embodiment, the wavelength may be 1300 nm. Thus, the wavelength identification code may describe the wavelength as 1300 nm.

The method 100 may further include a step 104 of integrating the wavelength identification code into one or more data burst(s) associated with the emitted light. In at least some embodiments, integration may utilize digitally coded American Standard Code for Information Interchange (ASCII) strings or other similar coding schemes. Other exemplary coding schemes include multi-byte (>2 bytes) ASCII strings, hexadecimal binary coding, e.g., 2-bytes of hexadecimal string, or analog tone frequency coding. Use of analog tone frequency coding, while simple to generate, may require use of Fast Fourier Transform to properly detect the wavelength identification code. Meanwhile, digital coding may offer more flexibility and simple coding and detection schemes.

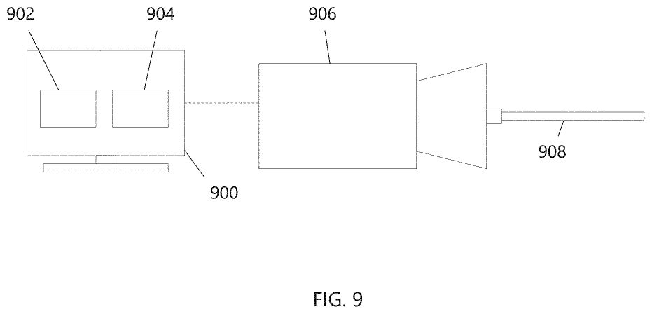

In an embodiment, at least some steps in the method 100, e.g., wavelength identification code generation at step 102 or integration of the wavelength identification code into the data burst(s) at step 104, may be performed by a device 900, illustrated by way of example in FIG. 9. In an embodiment, the device 900 may be configured and operable to cause such other components to perform the various operations and method steps as discussed herein.

The device 900 may include processing circuitry 902 coupled to memory storage 904. The processing circuitry 902 can include one or more processor(s) configured to perform a variety of computer-implemented functions, as discussed herein. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory storage 904 may generally comprise local memory element(s) including, but not limited to, computer readable medium (e.g., random access memory (RAM)), computer readable non-volatile medium (e.g., flash memory), a floppy disk, a compact disc-read only memory (CD-ROM), a magneto-optical disk (MOD), a digital versatile disc (DVD), and/or other suitable memory elements including remote storage, e.g., in a network cloud. Such memory storage may generally be configured to store suitable computer-readable instructions that, when implemented by the processor(s), configure the processing circuitry 902 to perform various computer-implemented functions including, but not limited to, performing the various steps discussed herein. In addition, the processing circuitry 902 may also include various input/output channels for receiving inputs from and for sending control signals to the various other components of the device 900, including a light source, such as a tunable or wavelength-adjustable light source.

After determining the wavelength of the light, the processing circuitry 902 can generate the wavelength identification code and communicate the wavelength identification code to a tunable light source 906 configured to emit the light into an optical fiber 908. The processing circuitry 902 may further integrate the wavelength identification code into the data burst(s) associated with the light at step 104. In this regard, the device 900 may create and code the wavelength identifier for DWDM and CWDM light sources, such as an identifier for each wavelength of a multiplexed signal comprising multiple wavelengths, into the transmission to permit easier testing and measurement of fiber optic networks.

In some embodiments, the method 100 may further include a step 106 of emitting the light into the optical fiber. The emitted light in step 106 may include the wavelength identification code coded into the transmission. As described in greater detail herein, step 106 can be performed with a tunable light source configured to generate selective wavelength transmissions. One exemplary light source includes a tunable laser coupled with a burst generator (not illustrated). Another exemplary light source includes a plurality of discrete light sources that may emit light into the optical fiber. For example, the light source can include a plurality of lasers, e.g., 2 to 10 lasers, that can be selected for DWDM and CWDM applications. In an embodiment, at least one of the plurality of light sources can be a fixed wavelength light source, e.g., a fixed wavelength laser. Through combining a plurality of fixed wavelength light sources (or one or more fixed wavelength light sources with one or more wavelength-adjustable light sources), the light emitted into the optical fiber can be understood as having been emitted from a wavelength-adjustable light source.

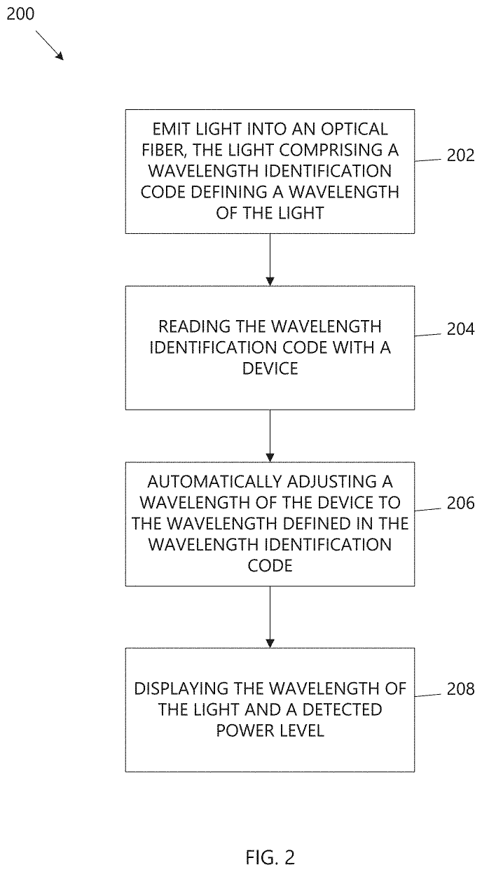

In another exemplary method 200 of wavelength identification, illustrated in FIG. 2, a step 202 may include emitting light from a light source into an optical fiber. The light may include a wavelength identification code defining a wavelength of the light. As discussed herein, the wavelength identification code can provide a wavelength value of the emitted light (e.g., 1310 nm or 1500 nm). The wavelength identification code may be part of the data burst(s) provided by the light source. In at least some embodiments, the wavelength identification code can be digitally coded ASCII strings, multi-byte (>2 bytes) ASCII strings, hexadecimal binary coding, e.g., 2-bytes of hexadecimal string, analog tone frequency coding, or another digital and/or analog coding scheme.

The method 200 may further include a step 204 of reading the wavelength identification code with a device. The device may include, for example, an optical power meter (OPM). The OPM may be disposed at a receiving end of the optical fiber, e.g., at a connector. The OPM may receive the light from the optical fiber and determine the wavelength of the light from the wavelength identification code contained in the light burst(s). More specifically, the OPM can determine the wavelength of the light by decoding the light bursts associated with the wavelength identification code.

The method 200 may also include a step 206 of automatically adjusting, e.g., automatically calibrating, from an existing or default wavelength of the device, e.g., the OPM, to the wavelength defined in the wavelength identification code of the received light. For example, the device may initially be set to a first wavelength prior to reading the wavelength identification code associated with incoming light burst(s). The first wavelength may be associated with a default startup wavelength of the device or a previous wavelength detected by the device in a different optical fiber. The device may automatically adjust from the first wavelength to the updated (second) wavelength associated with the received light in response to reading (and optionally decoding) the wavelength identification code from the received light. For instance, the device may be initially set to a first wavelength (e.g., 1310 nm). Transmitted light received by the device can have a second wavelength (e.g., 1510 nm) different from the first wavelength. The received light can further include a wavelength identification code defining the second wavelength. The wavelength identification code contained in the second wavelength can describe the second wavelength (i.e., 1510 nm) to the receiving device, e.g., the OPM. The receiving device can then automatically adjust, e.g., tune, from the first wavelength (e.g., 1310 nm) to the second wavelength (e.g., 1510 nm).

In an embodiment, the device can continuously monitor light burst(s) for incoming wavelength identification codes. In another embodiment, the device can periodically monitor for wavelength identification codes. In certain instances, incoming wavelength identification codes can automatically trigger the device to read the wavelength information contained in the wavelength identification code.

In an embodiment, the method 200 may further include a step 208 of displaying the wavelength of the light and a detected power level of the light. The wavelength and/or detected power level of the light may be displayed on a user interface, such as a screen of the device.

In an embodiment, the power level of the light may be determined by measuring the power of the received light, e.g., by the OPM and comparing the measured power to a referenced power of the light source. More particularly, by subtracting the referenced power from the measured power, the power loss of the optical fiber can be determined. Detecting the power level may be done without requiring the technician to manually adjust the wavelength settings of the device as the device automatically adjusts to the correct wavelength in response to the received wavelength identification code. The detected power level may be displayed in decibels (dB) to provide optical loss, decibel-milliwatts (dBm) to provide optical power, milliwatts (mW), or another suitable measure.

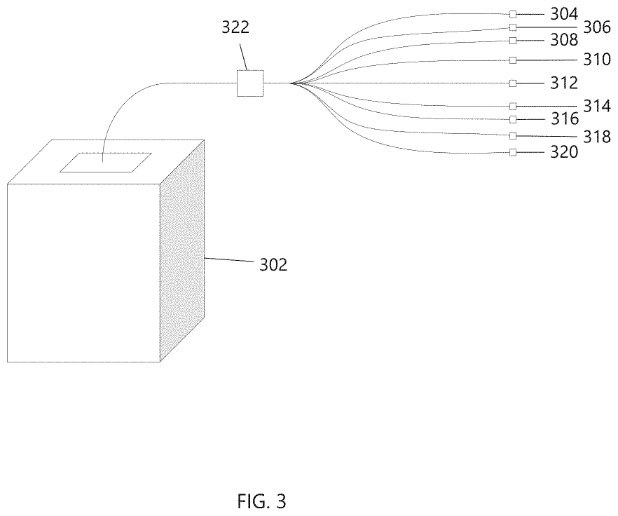

Any suitable light source may be used to emit the light in various embodiments of the present methods. In an embodiment, the light source includes a tunable light source allowing for selective wavelength transmission. By way of example, the light source can include a laser capable of generating DWDM and/or CWDM wavelengths and coding each wavelength with the wavelength identification code. A schematic of an exemplary laser 302 is illustrated in FIG. 3. As illustrated in FIG. 3, the laser 302 may be connected to a plurality of optical fibers. In the illustrated example embodiment, the laser 302 can be connected to nine optical fibers 304, 306, 308, 310, 312, 314, 316, 318, and 320, e.g., via a fan out connector 322. Each optical fiber 304, 306, 308, 310, 312, 314, 316, 318, and 320 can carry the plurality of wavelengths generated by the laser 302. Accordingly, in some embodiments, the method may include the identification of wavelengths in a plurality of optical fibers, e.g., nine fibers. The plurality of optical fibers may include any suitable numbers of fibers, e.g., two optical fibers, three optical fibers, up to and including nine or more optical fibers. As illustrated, each of the optical fibers can terminate in a corresponding connector configured to engage with an optical port.

In another embodiment, the laser 302 of FIG. 3 can be in optical communication with a WDM demux (filter) 322 which can separate multi-wavelength light emitted by the laser 302 into separate wavelengths, e.g., λ₁, λ₂, λ₃, λ₄, λ_{N}, each received by one or more of the plurality of optical fibers, e.g., optical fibers 304, 306, 308, 310, 312, 314, 316, 318, and 320. Each optical fiber can transmit that wavelength(s) to an output where the output can be verified as having the correct wavelength labeling using methods and devices as described in greater detail herein.

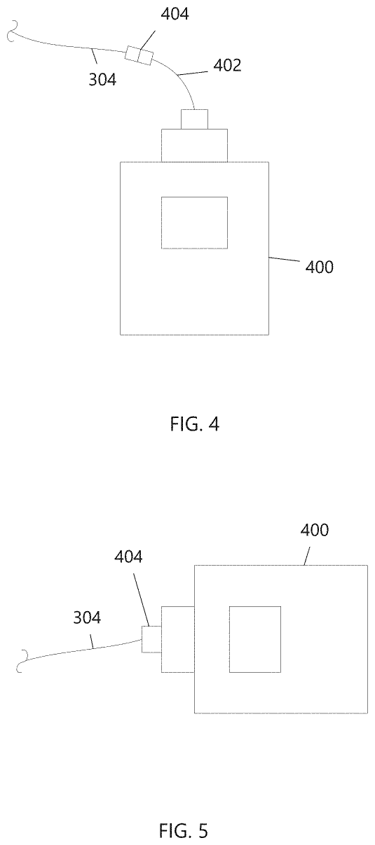

The light transmitted from the laser 302 may include the wavelength identification code as part of the transmission. The wavelength identification code may advantageously permit a technician to quickly and effectively identify the wavelength of the transmitted signal. In an embodiment, the wavelength identification code can be read by a device configured to access the light from the optical fiber. One suitable device for reading the wavelength identification code is the OPM, such as the exemplary OPM 400 illustrated in FIGS. 4 and 5. The OPM 400 is generally operable to detect and measure the power of light at one or more predetermined wavelengths or ranges of wavelengths. In general, an OPM, such as OPM 400, may convert received light into an electrical signal for measurement and/or display purposes. As illustrated for example in FIG. 4, the OPM 400 may be connected to a jumper 402 which may interconnect the OPM 400 with a connector 404, e.g., the connector at the end of optical fiber 304, on the terminal end of a selected one of the plurality of optical fibers. In various embodiments, the jumper 402 may be interconnected with the connector 404 with or without contacting the optical fiber, e.g., the connection may be a contact or non-contact connection. Thus, one of ordinary skill in the art will recognize that connecting the jumper 402 to the connector 404 includes placing the optical fiber 304 in optical communication with the OPM 400 and may include, but does not necessarily include, physically connecting the optical fiber to the OPM 400. In another example, as illustrated in FIG. 5, the OPM 400 may be directly connected to the connector 404 on the second end of a selected one of the plurality of optical fibers, e.g., optical fiber 304, in order to detect the wavelength and power level of the transmitted light. In various embodiments, the direct connection may be a contact or non-contact connection, as described above with respect to the jumper 402 in FIG. 4.

The light source, e.g., laser 302, may include a laser source operable to generate a laser beam of any suitable wavelength. In an embodiment, the laser 302 includes a tunable laser configured to selectively emit light of various wavelengths. The laser 302 is further configured to transmit the wavelength identification code within the transmitted light. For example, FIG. 6 illustrates a single wavelength transmission optical output configuration 600 including a light signal 602 having a wavelength identification code 604 and a measurement window 606. The wavelength identification code 604 can be repeated for each successive light signal 602 of the single wavelength coded signal 600. The measurement window 606 may include the portion of the light signal 602 over which the power measurement performed by the device occurs. That is, power measurement and wavelength identification can be transmitted in different, discrete portions of the light burst(s).

Each wavelength identification code 604 can define a duration, D_{WIC}. For example, the duration of D_{WIC} may be between about 1 millisecond (ms) and about 10 ms, such as between about 2 ms and about 8 ms, such as between about 3 ms and 6 ms. In an embodiment, the remaining portion of the light signal 602 can include the measurement window 606. For example, the measurement window 606 can define a duration, D_{MW}, between about 500 ms and about 1 second, such as between about 800 ms and about 999 ms, such as between about 950 ms and about 998 ms, such as between about 990 ms and about 997 ms.

As illustrated in FIG. 8, the wavelength identification code 604 may include data bursts 800 including one or more multi-bit data bursts, such as for example, an eight-bit data burst 802. It should be understood that reference to any particular sized data burst or particular byte or bit is done for exemplary purposes and may be different from that described in one or more embodiments. By way of example, the eight-bit data burst 802 can define a first byte. The eight-bit data burst 802 may include a start bit 804 configured to identify the wavelength identification code 604. The start bit 804 may include, for example, a ‘1’ to identify the wavelength identification code. The next three bits 806 of the first byte, e.g., bits two through four, may be configured to identify a quantity of wavelengths of the light corresponding to the wavelength identification code 604. The last four bits 808 of the first byte, e.g., bits five through eight, may be configured to define a selector value configured to identify a quantity of DWDM wavelengths in a second byte 810. A selector value of 0 may support up to 100 wavelengths in byte 2 for 50 GHz S-Band spacing. A selector value of 1 may support up to 100 wavelengths in byte 2 for 50 GHz C-Band spacing. A selector value of 2 may support 100 wavelengths in byte 2 for 50 GHz L-Band spacing. Without wishing to be bound to a particular theory, it is believed that greater selector values may be used to support S-Band, C-Band, and L-Band spacing applications or applications requiring a third wavelength identification code byte to support additional wavelengths and/or any extra number of wavelengths within the transmitted sequence.

In the embodiment illustrated in FIG. 8, the exemplary second byte 810 includes the DWDM channel wavelength and a start bit 804 containing ‘1’. In other embodiments, a third byte (not illustrated) may be used to support additional wavelengths and/or any extra number of wavelengths within the transmitted sequence. The above description of an eight-bit data burst 802 is illustrated by way of example. In other embodiments, the data burst may include, for example, a single 16-bit data burst, a single 24-bit data burst, etc. Moreover, in one or more embodiments, the data burst may include a single data bit string longer or shorter than the exemplary two or three byte example previously described.

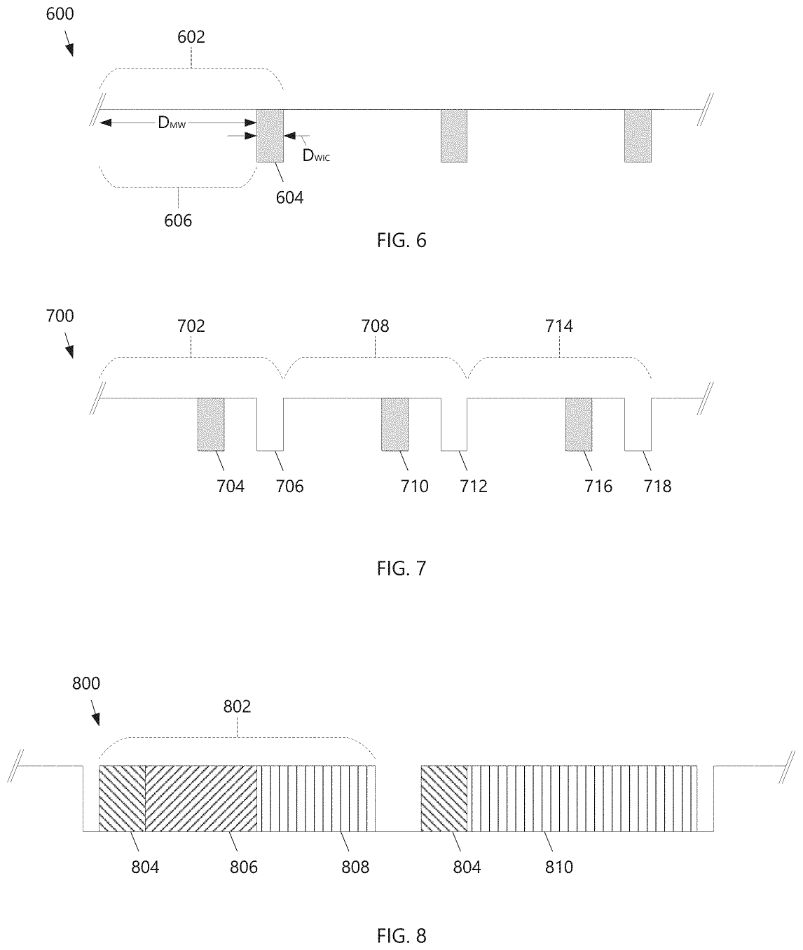

FIG. 7 illustrates a multiple wavelength transmission optical output configuration 700 including a first light signal 702 defining a first wavelength identification code 704 and a wavelength change signal 706 configured to signal to the OPM of an impending wavelength shift, a second light signal 708 defining a second wavelength identification code 710 and a wavelength change signal 712, and a third light signal 714 defining a third wavelength identification code 716 and a wavelength change signal 718. Each of the wavelength identification codes 704, 710, and 716 can define the wavelength value (e.g., 1310 nm or 1550 nm) of its respective light signal 702, 708, and 714. The wavelength change signals 706, 712, and 718 can signal to the OPM that a wavelength shift is impending, thus permitting the OPM to differentiate between discrete wavelengths and adjust or tune its wavelength accordingly.

Wavelength identification using wavelength identification coding provided in the wavelength transmission may advantageously permit technicians to quickly identify WDM demux (filter) outputs in the event of output labeling errors. Since there is no wavelength filtering or demultiplexing involved, the cost and complexity of wavelength identification is greatly reduced. Further, use of wavelength identification coding eliminates the need for expensive optics and filtering technology required to determine the wavelength at the filter outputs and eliminates the bulk of instrumentation needed for quick and accurate analysis. For example, an optical power meter (OPM) may replace previously required channel checkers, Optical Spectrum Analyzers (OSA), and WDM Health Meters which utilize costly wavelength filtering technology and are limited by the range of wavelengths detectable due to filter integration. OPMs are readily available, easy to use, and cost effective in comparison to filter technology. The use of wavelength coded transmissions as described in accordance with aspects herein can enable greater use of OPMs to replace expensive, existing technologies.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

### Embodiment 1

A device configured for use with an optical fiber, the device comprising processing circuitry coupled to storage, the processing circuitry configured to: generate a wavelength identification code defining a wavelength associated with a light; integrate the wavelength identification code into a data burst associated with the light; and communicate the data burst to a wavelength-adjustable light source configured to emit the light into the optical fiber.

### Embodiment 2

The device of any one or more of the embodiments, wherein the wavelength identification code comprises a data string.

### Embodiment 3

The device of any one or more of the embodiments, wherein at least one bit of the data burst is configured to identify the wavelength identification code.

### Embodiment 4

The device of any one or more of the embodiments, wherein at least one different bit of the data burst is configured to identify a quantity of wavelengths of the light corresponding to the wavelength identification code.

### Embodiment 5

The device of any one or more of the embodiments, wherein the processing circuitry is further configured to determine the wavelength associated with the light, the light being selectable from a range of wavelengths.

### Embodiment 6

A method of wavelength identification in an optical fiber, the method comprising: generating a wavelength identification code defining a wavelength associated with a light to be emitted into the optical fiber; integrating the wavelength identification code into a data burst associated with the light; and emitting the light into the optical fiber.

### Embodiment 7

The method of any one or more of the embodiments, wherein the step of emitting light into the optical fiber is performed with a wavelength-adjustable light source.

### Embodiment 8

The method of any one or more of the embodiments, wherein the data burst is part of a byte of data associated with the light.

### Embodiment 9

The method of any one or more of the embodiments, wherein emitting the light into the optical fiber is performed after integrating the wavelength identification code into the data burst.

### Embodiment 10

The method of any one or more of the embodiments, wherein the wavelength associated with the light is generally in a range of 1270 nanometers (nm) and 1625 nm.

### Embodiment 11

The method of any one or more of the embodiments, further comprising: receiving the light at an optical power meter; and automatically adjusting a wavelength of the optical power meter to the wavelength defined in the wavelength identification code.

### Embodiment 12

A method of wavelength identification in an optical fiber, the method comprising: emitting light into the optical fiber, the light comprising a wavelength identification code defining a wavelength of the light; reading the wavelength identification code with a device; automatically adjusting a wavelength of the device to the wavelength defined in the wavelength identification code; and displaying the wavelength of the light and a detected power level.

### Embodiment 13

The method of any one or more of the embodiments, further comprising: adjusting the light to a second wavelength; reading a second wavelength identification code defined within the second wavelength; automatically adjusting the wavelength of the device to the second wavelength; and displaying the second wavelength of the light and the detected power level.

### Embodiment 14

The method of any one or more of the embodiments, further comprising coupling the device to a different optical fiber if the displayed wavelength is different than expected.

### Embodiment 15

The method of any one or more of the embodiments, wherein the device is an optical power meter.

### Embodiment 16

The method of any one or more of the embodiments, wherein the step of emitting light into the optical fiber is performed with a wavelength-adjustable light source.

### Embodiment 17

The method of any one or more of the embodiments, wherein the wavelength identification code comprises a multi-bit data burst.

### Embodiment 18

The method of any one or more of the embodiments, wherein at least one bit of the multi-bit data burst is configured to identify the wavelength identification code.

### Embodiment 19

The method of any one or more of the embodiments, wherein at least one different bit of the multi-bit data burst is configured to identify a quantity of wavelengths of the light corresponding to the wavelength identification code.

### Embodiment 20

The method of any one or more of the embodiments, wherein at least one bit of the multi-bit data burst is configured to define a selector value configured to identify a quantity of wavelengths in another byte of the multi-bit data burst.

What is claimed is:

1. A device configured for use with an optical fiber, the device comprising processing circuitry coupled to storage, the processing circuitry configured to:
generate a wavelength identification code defining a wavelength associated with a light;
integrate the wavelength identification code into a data burst associated with the light; and
communicate the data burst to a wavelength-adjustable light source configured to emit the light into the optical fiber.

2. The device of claim 1, wherein the wavelength identification code comprises a data string.

3. The device of claim 1, wherein at least one bit of the data burst is configured to identify the wavelength identification code.

4. The device of claim 3, wherein at least one different bit of the data burst is configured to identify a quantity of wavelengths of the light corresponding to the wavelength identification code.

5. The device of claim 1, wherein the processing circuitry is further configured to determine the wavelength associated with the light, the light being selectable from a range of wavelengths.

6. A method of wavelength identification in an optical fiber, the method comprising:
generating a wavelength identification code defining a wavelength associated with a light to be emitted into the optical fiber;
integrating the wavelength identification code into a data burst associated with the light; and
emitting the light into the optical fiber.

7. The method of claim 6, wherein the step of emitting light into the optical fiber is performed with a wavelength-adjustable light source.

8. The method of claim 6, wherein the data burst is part of a byte of data associated with the light.

9. The method of claim 6, wherein emitting the light into the optical fiber is performed after integrating the wavelength identification code into the data burst.

10. The method of claim 9, wherein the wavelength associated with the light is generally in a range of 1270 nanometers (nm) and 1625 nm.

11. The method of claim 9, further comprising:
receiving the light at an optical power meter; and
automatically adjusting a wavelength of the optical power meter to the wavelength defined in the wavelength identification code.

12. A method of wavelength identification in an optical fiber, the method comprising:
emitting light into the optical fiber, the light comprising a wavelength identification code defining a wavelength of the light;
reading the wavelength identification code with a device;
automatically adjusting a wavelength of the device to the wavelength defined in the wavelength identification code; and
displaying the wavelength of the light and a detected power level.

13. The method of claim 12, further comprising:
adjusting the light to a different wavelength;
reading a wavelength identification code defined within the different wavelength;
automatically adjusting the wavelength of the device to the different wavelength; and
displaying the different wavelength of the light and the detected power level.

14. The method of claim 12, further comprising:
coupling the device to a different optical fiber if the displayed wavelength is different than expected.

15. The method of claim 12, wherein the device is an optical power meter.

16. The method of claim 12, wherein the step of emitting light into the optical fiber is performed with a wavelength-adjustable light source.

17. The method of claim 12, wherein the wavelength identification code comprises a multi-bit data burst.

18. The method of claim 17, wherein at least one bit of the multi-bit data burst is configured to identify the wavelength identification code.

19. The method of claim 18, wherein at least one different bit of the multi-bit data burst is configured to identify a quantity of wavelengths of the light corresponding to the wavelength identification code.

20. The method of claim 17, wherein at least one bit of the multi-bit data burst is configured to define a selector value configured to identify a quantity of wavelengths in another byte of the multi-bit data burst.
